(19) United States
(12) Patent Application Publication
(10) Pub. No.: US 2020/0253167 A1
(43) Pub. Date: Aug. 13, 2020

(54) Liquid Hummingbird Feeder Assembly

(71) Applicant: Edna Ellis-Durden, Taunton, MA (US)

(72) Inventor: Edna Ellis-Durden, Taunton, MA (US)

(21) Appl. No.: 16/274,318

(22) Filed: Feb. 13, 2019

(51) Int. Cl. A01K 39/02; A01K 39/012

(52) U.S. Cl. CPC A01K 39/0206; A01K 39/012

(57) ABSTRACT

A liquid hummingbird feeder assembly includes a container for containing a fluid solution of hummingbird nectar. An engagement is coupled to the container and the engagement releasably engages a support for suspending the container from the support. A base is provided and the container is removably coupled thereto. The base closes the container when the container is removably coupled thereto to inhibit the fluid solution from spilling out of the container. The base has a plurality of dispensers that is each integrated into the base and each of the dispensers is in fluid communication with the container when the container is removably coupled to the base. In this way each of the dispensers can dispense the fluid solution to hummingbirds for feeding.

### (b) CROSS-REFERENCE TO RELATED APPLICATIONS

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to feeder devices and more particularly pertains to a new feeder device for feeding liquid nectar to hummingbirds.

### (h) BRIEF SUMMARY OF THE INVENTION

An embodiment of the disclosure meets the needs presented above by generally comprising a container for containing a fluid solution of hummingbird nectar. An engagement is coupled to the container and the engagement releasably engages a support for suspending the container from the support. A base is provided and the container is removably coupled thereto. The base closes the container when the container is removably coupled thereto to inhibit the fluid solution from spilling out of the container. The base has a plurality of dispensers that is each integrated into the base and each of the dispensers is in fluid communication with the container when the container is removably coupled to the base. In this way each of the dispensers can dispense the fluid solution to hummingbirds for feeding.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a liquid hummingbird feeder assembly according to an embodiment of the disclosure.

FIG. 2 is a front view of an embodiment of the disclosure.

FIG. 3 is a bottom view of an embodiment of the disclosure.

FIG. 4 is a cross sectional view taken along line 4-4 of FIG. 3 of an embodiment of the disclosure.

### (j) DETAILED DESCRIPTION OF THE INVENTION

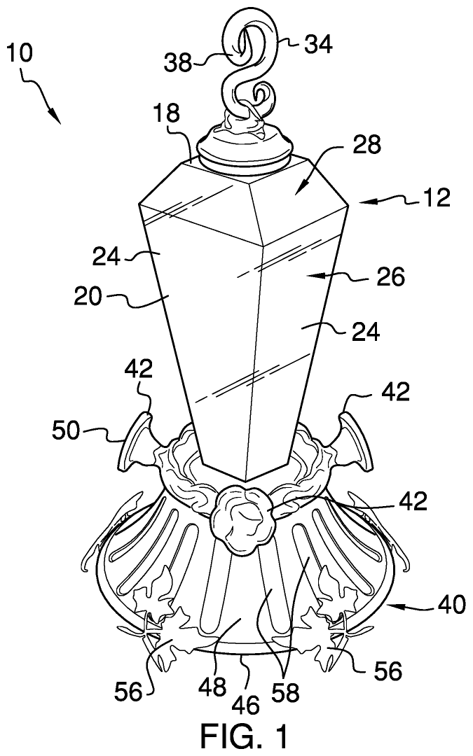

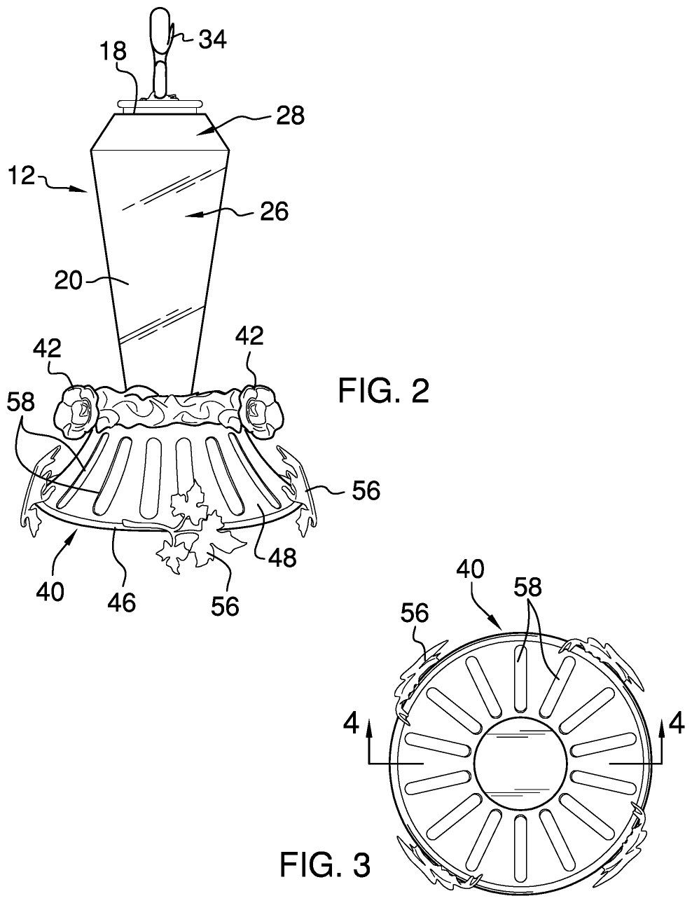

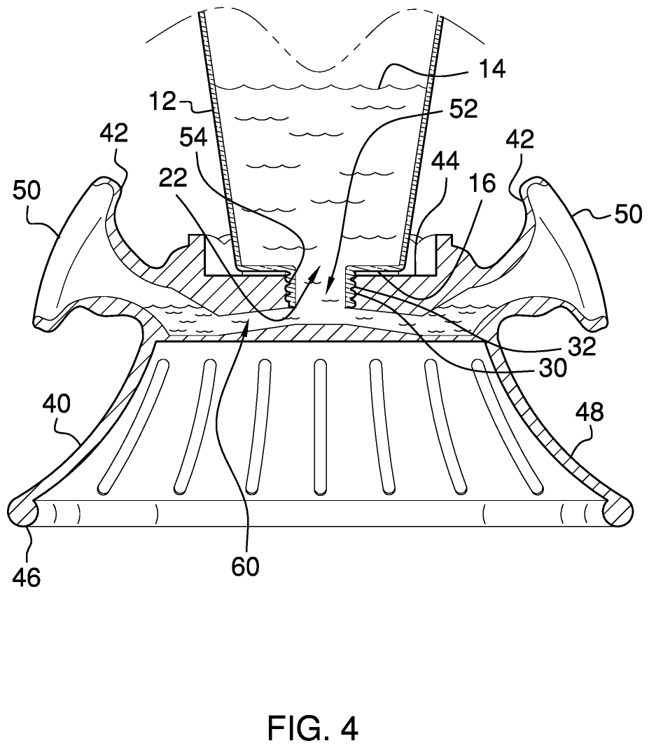

With reference now to the drawings, and in particular to FIGS. 1 through 4 thereof, a new feeder device embodying the principles and concepts of an embodiment of the disclosure and generally designated by the reference numeral 10 will be described.

As best illustrated in FIGS. 1 through 4, the liquid hummingbird feeder assembly 10 generally comprises a container 12 for containing a fluid solution 14 of hummingbird nectar. The container 12 has a bottom end 16, a top end 18 and an outer wall 20 extending therebetween, and the bottom end 16 has an opening 22 extending into an interior of the container 12 for filling the container 12. The container 12 is elongated between the top 18 and bottom 16 ends and the outer wall 20 has a plurality of intersecting sides 24 each extending between the top 18 and bottom 16 ends. Thus, the container 12 has a rectilinear cross section taken along an axis extending through the top 18 and bottom 16 ends. Each of the intersecting sides 24 may have a first angled portion 26 lying on a plane forming an angle with a second angled portion 28 such that the container 12 has an elongated gem shape.

The bottom end 16 has a neck 30 extending downwardly therefrom and the neck 30 is aligned with the opening 22 in the bottom end 16 such that the fluid solution 14 flows through the neck 30. The neck 30 has an outer surface 32 and the outer surface 32 is threaded. An engagement 34 is coupled to the container 12 and the engagement 34 releasably engages a support for suspending the container 12 from the support. The support might be a tree branch, a bird feeder holder or any other elevated support that is positioned outdoors. The engagement 34 is coupled to the top end 18 of the container 12 and the engagement 34 has a distal end 38 with respect to the top end 18. Moreover, the engagement 34 is curved between the container 12 and the distal end 38 to define a hook for engaging the support. The engagement 34 may include an ornamental base that sits on the top end 18 of the container 12.

A base 40 is provided and the container 12 is removably coupled to the base 40. Moreover, the base 40 closes the container 12 when the container 12 is removably coupled thereto to inhibit the fluid solution 14 from spilling out of the container 12. The base 40 has a plurality of dispensers 42 that is each integrated into the base 40. Each of the dispensers 42 is in fluid communication with the container 12 when the container 12 is removably coupled to the base 40. In this way each of the dispensers 42 can dispense the fluid solution 14 to hummingbirds for feeding.

The base 40 has an upper end 44, a lower end 46 and an exterior wall 48 extending therebetween, and the exterior wall 48 is continuously arcuate about a vertical axis of the base 40 such that the base 40 has a rounded shape. Each of the dispensers 42 extends outwardly from the exterior wall 48, and the dispensers 42 are spaced apart from each other and are distributed around the exterior wall 48. Additionally, each of the dispensers 42 has a distal end 50 with respect to the exterior wall 48. The upper end 44 has a well 52 extending downwardly toward the lower end 46 and the well 52 has a bounding surface 54. The outer surface 32 of the neck 30 on the bottom end 16 of the container 12 threadably engages the bounding surface 54. In this way the container 12 is removably retained on the base 40.

The upper end 44 of the base 40 may have a diameter that is less than a diameter of the lower end 46 of the base 40. Additionally, each of the dispensers 42 may be positioned closer to the upper end 44 than the lower end 46. The exterior wall 48 of the base 40 may have a plurality of ornamental leaves 56 bonded thereto and the exterior wall 48 may include ornamental fluting 58 that extends substantially between the lower end 46 of the base 40 and the dispensers 42.

The base 40 has a conduit 60 that is integrated therein and the conduit 60 intersects the well 52. Thus, the conduit 60 receives the fluid solution 14 when the container 12 is releasably coupled to the base 40. Moreover, the conduit 60 branches outwardly from the well 52 through the distal end 50 of each of the dispensers 42. In this way the fluid solution 14 is accessible through each of the dispensers 42 for feeding a hummingbird. The conduit 60 angles upwardly through each of the dispensers 42 thereby inhibiting the fluid solution 14 from pouring outwardly from the dispensers 42. Moreover, each of the dispensers 42 flares outwardly between the exterior wall 48 of the base 40 and the distal end 50 of the dispensers 42 such that each of the dispensers 42 resembles a floral blossom.

In use, the container 12 is removed from the base 40, the container 12 is inverted and the container 12 is filled with the fluid solution 14 for feeding the hummingbirds. The base 40 is screwed onto the container 12, and both the container 12 and the base 40 are subsequently uprighted. Thus, the fluid solution 14 flows into the well 52 in the base 40 and into the conduit 60 in the base 40. The engagement 34 is positioned on the support 36 to suspend the container 12 and the base 40. In this way the dispensers 42 are available for hummingbirds to feed on the fluid solution 14 that is in the conduit 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A liquid hummingbird feeder assembly being configured to contain and feed nectar to hummingbirds, said assembly comprising:
a container for containing a fluid solution of hummingbird nectar;
an engagement being coupled to said container, said engagement releasably engaging a support for suspending said container from the support; and
a base having said container being removably coupled thereto, said base closing said container when said container is removably coupled thereto to inhibit the fluid solution from spilling out of said container, said base having a plurality of dispensers each being integrated into said base, each of said dispensers being in fluid communication with said container when said container is removably coupled to said base wherein each of said dispensers is configured to dispense the fluid solution to hummingbirds for feeding.

2. The assembly according to claim 1, wherein:
said container has a bottom end, a top end and an outer wall extending therebetween, said bottom end having an opening extending into an interior of said container for filling said container, said container being elongated between said top and bottom ends, said outer wall having a plurality of intersecting sides each extending between said top and bottoms ends such that said container has a rectilinear cross section taken along an axis extending through said top and bottom ends; and
said bottom end has a neck extending downwardly therefrom, said neck being aligned with said opening in said bottom end such that the fluid solution flows through said neck, said neck having an outer surface, said outer surface being threaded.

3. The assembly according to claim 2, wherein said engagement is coupled to said top end of said container, said engagement having a distal end with respect to said top end, said engagement being curved between said container and said distal end to define a hook for engaging the support.

4. The assembly according to claim 2, wherein said base has an upper end, a lower end and an exterior wall extending therebetween, said exterior wall being continuously arcuate about a vertical axis of said base such that said base has a rounded shape, each of said dispensers extending outwardly from said exterior wall, said dispensers being spaced apart from each other and being distributed around said exterior wall, each of said dispensers having a distal end with respect to said exterior wall.

5. The assembly according to claim 4, wherein said upper end has a well extending downwardly toward said lower end, said well having a bounding surface, said outer surface of said neck on said bottom end of said container threadably engaging said bounding surface for removably retaining said container on said base.

6. The assembly according to claim 5, wherein said base has a conduit being integrated therein, said conduit intersecting said well such that said conduit receives the fluid solution when said container is releasably coupled to said base, said conduit branching outwardly from said well and through said distal end of each of said dispensers thereby facilitating the fluid solution to be accessible through each of said dispensers wherein each of said dispensers is configured to feed a hummingbird.

7. The assembly according to claim 6, wherein said conduit angles upwardly through each of said dispensers thereby inhibiting the fluid solution from pouring outwardly from said dispensers, each of said dispensers flaring outwardly between said exterior wall of said base and said distal end of said dispensers such that each of said dispensers resembles a floral blossom.

8. A liquid hummingbird feeder assembly being configured to contain and feed nectar to hummingbirds, said assembly comprising:
a container for containing a fluid solution of hummingbird nectar, said container having a bottom end, a top end and an outer wall extending therebetween, said bottom end having an opening extending into an interior of said container for filling said container, said container being elongated between said top and bottom ends, said outer wall having a plurality of intersecting sides each extending between said top and bottoms ends such that said container has a rectilinear cross section taken along an axis extending through said top and bottom ends, said bottom end having a neck extending downwardly therefrom, said neck being aligned with said opening in said bottom end such that the fluid solution flows through said neck, said neck having an outer surface, said outer surface being threaded;
an engagement being coupled to said container, said engagement releasably engaging a support for suspending said container from the support, said engagement being coupled to said top end of said container, said engagement having a distal end with respect to said top end, said engagement being curved between said container and said distal end to define a hook for engaging the support; and
a base having said container being removably coupled thereto, said base closing said container when said container is removably coupled thereto to inhibit the fluid solution from spilling out of said container, said base having a plurality of dispensers each being integrated into said base, each of said dispensers being in fluid communication with said container when said container is removably coupled to said base wherein each of said dispensers is configured to dispense the fluid solution to hummingbirds for feeding, said base having an upper end, a lower end and an exterior wall extending therebetween, said exterior wall being continuously arcuate about a vertical axis of said base such that said base has a rounded shape, each of said dispensers extending outwardly from said exterior wall, said dispensers being spaced apart from each other and being distributed around said exterior wall, each of said dispensers having a distal end with respect to said exterior wall, said upper end having a well extending downwardly toward said lower end, said well having a bounding surface, said outer surface of said neck on said bottom end of said container threadably engaging said bounding surface for removably retaining said container on said base, said base having a conduit being integrated therein, said conduit intersecting said well such that said conduit receives the fluid solution when said container is releasably coupled to said base, said conduit branching outwardly from said well and through said distal end of each of said dispensers thereby facilitating the fluid solution to be accessible through each of said dispensers wherein each of said dispensers is configured to feed a hummingbird, said conduit angling upwardly through each of said dispensers thereby inhibiting the fluid solution from pouring outwardly from said dispensers, each of said dispensers flaring outwardly between said exterior wall of said base and said distal end of said dispensers such that each of said dispensers resembles a floral blossom.
